(19) United States
(12) Patent Application Publication
(10) Pub. No.: US 2008/0169248 A1
(43) Pub. Date: Jul. 17, 2008

(54) FIBER SEPARATOR SYSTEM

(76) Inventor: David DeWaard, Lynden, WA (US)

Correspondence Address: HUGHES LAW FIRM, PLLC, PACIFIC MERIDIAN PLAZA, SUITE 302, 4164 MERIDIAN STREET, BELLINGHAM, WA, 98226-5583, US

(21) Appl. No.: 12/013,172

(22) Filed: Jan. 11, 2008

Related U.S. Application Data
(60) Provisional application No. 60/884,461, filed on Jan. 11, 2007.

(51) Int. Cl. C02F 9/02

(52) U.S. Cl. 210/747; 210/257.1; 210/772

(57) ABSTRACT

A rinsing system for rinsing fibrous material providing a separator with counter current flow of the fibrous material with respect to a rinsing fluid in a second separator. The system provides for a first separator which in one form removes water from the fibrous material to increase the dilution factor whereby the fibrous material in the second separator passes therethrough and in one form passes through a dewatering mechanism.

### RELATED APPLICATIONS

This application claims priority benefit of U.S. Ser. No. 60/884,461, filed Jan. 11, 2007.

### BACKGROUND OF THE DISCLOSURE

Separators, in particular fiber separators, have been utilized to remove fluid from fibrous material such as manure. In general, manure contains various substances and salts Oftentimes it is desirable to rinse and separate material such as salts or other content within material (such as manure) from an anaerobic digester. However, various challenges are in place for addressing a high volume of material from a digester. Therefore, provided herein is an apparatus and method for rinsing and separating particulate matter from raw material that can accommodate the volume of material that can be provided from a digester.

One reason for a fiber separator is for dairy manure management where material is positioned around the fiber portion of manure. Where one objective of a separator system is to rinse off and otherwise remove the salts and nutrients surrounding a fiber to provide a purified fibrous material. The raw fibrous material can have utility when removed from the nutrients for a basic filler material such as for potting soil as one example. The compounds surrounding the fibrous material can be for example salts, phosphates, potassium and nitrogen. Another goal rinsing the raw material is to remove the odor therefrom.

### SUMMARY OF THE DISCLOSURE

Disclosed herein is a fiber separation system for separating fluid from material such as fibrous material downstream of a digester. The fiber separation system has a first separator having an input and output region and a fluid discharge portion. There is further in one form a dewatering mechanism having a fluid output portion. Following the dewatering mechanism which can be of a variety of sorts there is a second separator having in one form a cylindrical foraminous member having an outer surface and an internal chamber where an internal augur is positioned.

The second separator also has an input region and an output region and a bath region being positioned between the input region and the output region. A base housing is provided forming a tub region with a baffle member having a partially circular portion configured to be positioned in close proximity to the outer surface of the cylindrical foraminous member being operatively configured to direct fluid from an upstream portion of the bath region to a downstream portion of the bath region. The fluid passes from the outer portion of the cylindrical foraminous member to the internal chamber. The fluid path is countercurrent to the general direction of movement of the fibrous material positioned within the cylindrical foraminous member where the fibrous material is biased in a forward direction by way of the internal augur member.

The fluid discharge portion of the first separator and the fluid output portion of the dewatering mechanism communicate and are operatively configured to transfer fluid to a fluid storage region.

The fiber separation system can have in input near the input region of the cylindrical foraminous member there is a first water discharge region which is in communication with a water separator member. In another form the water separator member has a lower solid content discharge which is in communication with the upstream portion of the base housing. In this form located near the output region of the cylindrical foraminous member there is a second fluid rinse operatively configured to discharge fluid having a lesser solid content than the water discharged through the lower solid content discharge of the water separator member. The higher solid content discharge of the water separating member can be in fluid communication with the fluid storage region. In this form the communication of the higher solid content discharge of the water separating member can be in communication with a discharge line that is further in communication with the fluid discharge portion of the first separator and the fluid output portion of the dewatering mechanism. With this communication system, the water separating member is a clarifier tank where the lower solid content discharge is positioned in the upper portion of the tank and the higher solid content discharge is positioned in the lower portion of the tank and a fluid control trap is in communication with the higher solid content discharge wherein the fluid control trap comprises first and second vertical conduits having an apex region which is positioned at a desirable height for the fluid height level of the fluid in the water separating member.

The fiber separating system can have a second dewatering mechanism follows the output region of the second separator where a fluid discharge region of the second watering mechanism is in communication with a clarifier tank and positioned near the input region of the second separator is a first water discharge region which is further in communication with the clarifier tank and a lower solid content discharge of the clarifier tank is in fluid communication with the upstream portion of the second separator. With the clarifier tank a second fluid rinse can be positioned in a more forward direction in the second separator with respect to the upstream portion whereby the second fluid rinse provides fluid with a lesser solid content than the fluid from the clarifier tank discharged through the lower solid content discharge to the upstream portion of the second separator.

A first embodiment show herein provides the second separator having a cylindrical foraminous member positioned at an angle whereby the input region is positioned at a lower elevation than the output region.

In one form a plurality of baffle members are positioned between the upstream portion and the downstream portion of the second separator. In one embodiment the first separator and the dewatering mechanism are both comprised within the inherent utility of a first cylindrical foraminous member having an internal augur. In this form the first cylindrical foraminous member is operatively connected to the second separator whereby the second separator is provided with the cylindrical foraminous member having a larger cross-sectional diameter than the first cylindrical foraminous member. Further the second separator can have the larger diameter cylindrical foraminous member positioned within the base housing at a first rinse portion that provides a tub for having fluid positioned therein and the base housing has a first rinse fluid input located in the upstream portion and a first rinse fluid output located in the downstream portion with the baffle member positioned therein between.

Other elements of the disclosure and configurations are disclosed herein by way of example.

### BRIEF DESCRIPTION OF THE DRAWINGS

FIG. 1 shows a schematic view of the separation system;

FIG. 2 shows a profile view taken along line 2-2 of FIG. 1 showing a baffle member;

FIG. 3 shows a schematic view of a second embodiment;

FIG. 4 shows a schematic view of a third embodiment.

### DESCRIPTION OF THE PREFERRED EMBODIMENTS

Disclosed herein are various embodiments shown by way of example for a separation system. In one preferred form, the separation system is configured to remove water and rinse out solids from fibrous material, such as manure or anaerobically digested cow manure. Of course in the broader scope, other raw materials can be utilized with the method and apparatus disclosed herein. A fibrous material can be define broadly in one form as material having a sufficient compilation of particulate matter at a sufficient cross-sectional diameter so as to be separated in the second separator described herein from fluid and not pass through the foraminous outer wall of the second separator.

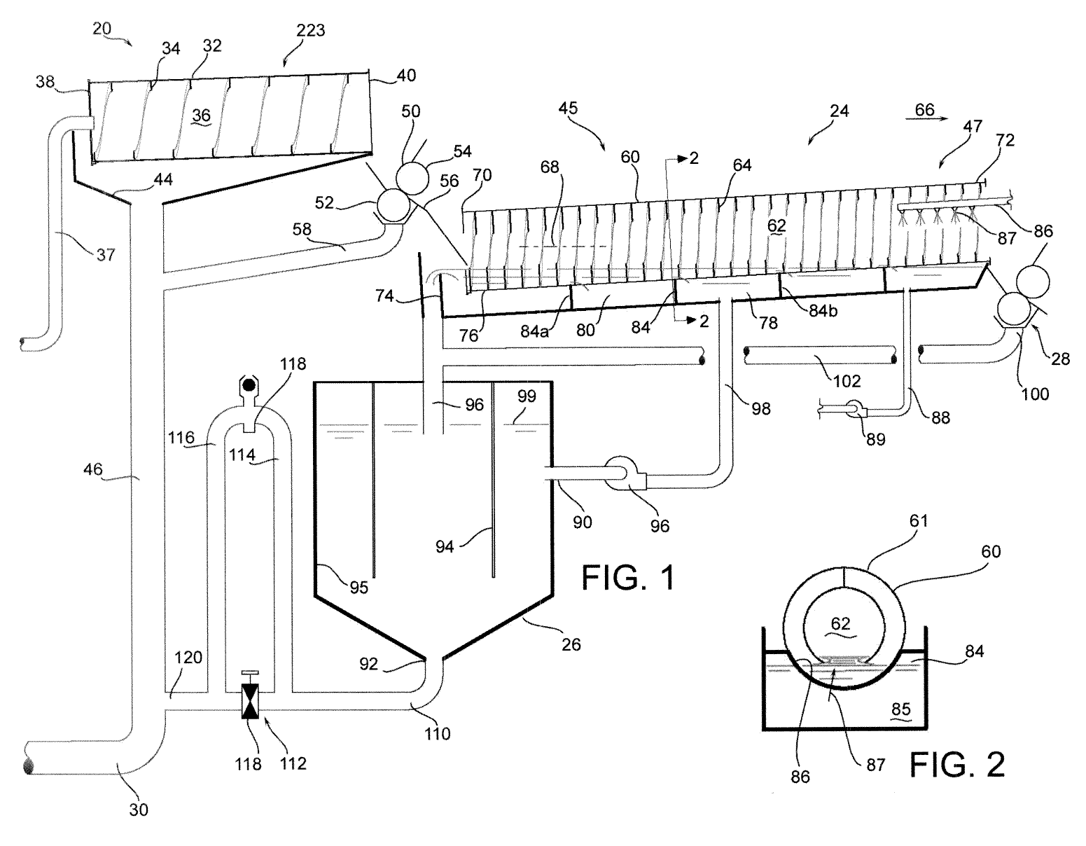

As shown in FIG. 1 there is the separation system 20 which generally comprises a first separator 22, a second separator 24 and a water separating member 26. There is further a dewatering mechanism 28 and a discharge line 30. FIG. 1 shows the first embodiment which will be described in detail. In general, the process generally comprises the steps of first positioning raw material, such as fibrous material, namely manure or the like in a first separator 22. In one form, the first separator as shown in FIG. 1 can be a rotary screen separator with a dewatering mechanism 50. Thereafter, the material enters the second separator 24 which has a first rinse region having a countercurrent flow in the tub region 76. In one form, the water from the clarifier tank 95 is used to provide rinsing water with a lower solid content than the solid content of the fluid intermixed with the fibrous material. This water is injected midstream in the second separator 24 and flows counter-currently to the advancement of the fibrous material contained within the chamber region 62 of the cylindrical member 60. Referring to FIG. 2, it can be appreciated that the water in the tub region 76 passes through the outer surface of the cylindrical member 60 to soak through the material contained therein. In one forms the baffle members 84 direct the rinsing water inwardly to the interior chamber portion of the cylindrical member 60. Referring now back to FIG. 1, thereafter, a second rinse is provided and a second dewatering mechanism 28 removes water from the material. It should be noted that water from the second dewatering mechanism in one form is transferred back to the clarifier retained 95, which is one form of a water separating member 26.

With the foregoing general description of the flow of material and water through the separation system 20, there will now be a more detailed description of the various components as well as the preferred method of processing the fibrous material.

As shown in the upper left-hand portion of FIG. 1, there is the first separator 22. In one form, the first separator 22 is a rotary screen member 32 having an internal advancing augur 34 to advance the fibrous material positioned within the chamber region 36. The rotary screen 32 further comprises an input region 38 and an output region 40. Positioned in the input region is an input line configured to transfer material therethrough, such as raw manure, or possibly material downstream from a digester. The first separator in one form has a fluid discharge portion 44 configured to retrieve fluids excreted from the material. In one form, the fluid discharge portion passes through line 46 to a long-term storage location, such as a fluid storage region like a lagoon through the discharge line 30.

In one form, the first separator further comprises a dewatering mechanism 50 which can be a press, such as a rotary press having first and second rotary members 52 and 54. The rotary press has one discharge portion 56 configured to pass the solid material therethrough and a fluid output portion 58. In one form the fluid output portion 58 is in communication with the line 46 to transfer this first-phase dewatered fluid from the manure to long-term storage. It should be reiterated that the first separator could be of a variety of designs, and the first separator 22 as shown in FIG. 1 is one example and other separators can be utilized in the system (including the separator 28) such as a centrifuge, screw press, sidehill, roller press, settling cell, belt press or any type of mechanism to lower the water content ratio of the material.

In general the fibrous material after leaving the dewatering mechanism 50 is transferred to the second separator 24. In one form the second separator 24 is comprised of a cylindrical member 60 which may be a cylindrical foraminous member. The foraminous member can be screened or otherwise have apertures or openings to allow fluid to pass therethrough but be of a sufficient diameter to have the raw fibrous material substantially maintained within the internal chamber 62. An internal helical member 64 is provided which is in one form an augur-like member to advance in the fibrous material contained therein. In one form, the internal helical member can be of a single helical design or of multiple helical members to increase the pitch along the longitudinal axis of the second separator. Therefore, the operation of the internal helical member is to advance the internal contents within the chamber region along the forward direction indicated by arrow 66.

In one form the cylindrical member is on an incline and the central axis 68 slopes upwardly from the input region 70 to the output region 72. As described herein, in other embodiments the central axis 68 is substantially level.

The second separator 24 comprises a base housing 74 which provides a tub region 76 to house a first rinsing fluid therein. In general, the second separator comprises a first rinse portion 45 and a second rinse portion 47. There will now be a detailed discussion of the first rinse portion 45.

In general, the first rinse portion 45 is comprised of a countercurrent flow system where incoming fluid through line 98 is directed to an upstream portion 78. The fluid from the upstream portion 78 travels countercurrent to the flow of material within the chamber region 62 and the fluid passes to a downstream portion 80. As shown in FIG. 2, interposed between the upstream and downstream portions is a baffle member 84. In one form, the baffle member has a partially circular surface 86 which is configured to engage the outer surface 61 of the cylindrical member. Therefore, the rinsing fluid 85 is configured to pass through the surface of this spherical member 60 as shown by arrow 87 so the fluid is directed to rinse through the contents within the chamber region 62. Referring now back to FIG. 1, it can be seen that in one form a plurality of baffle members 84a and 84b can be utilized.

The second rinse portion 47 is shown in the forward portion of the second separator 24 where a second fluid rinse 86 can for example have a plurality of discharge ports 87 disbursing fluid with a lower solid content than the fluid within line 98. For example, the fluid from the second fluid rinse 86 can be fresh water, while the fluid introduced through the line 98 is partially clarified water to the water separating member 26 described immediately herein below. The fluid line 88 can further provide water to the second rinse portion, or a fluid biasing member such as a pump 89 can be utilized or otherwise water may be distributed via hydrostatic pressure or another type of water introductory system.

The water separating member 26 in one form is a clarifier tank. In general, the water separating member has a lower solid content discharge 90 and a higher solid content discharge 92. In one form, the internal member 94 directs incoming water through the line 96 downwardly. In general, the incoming water through line 26 has a solid content wherein the diameter of the water separating member/clarifier tank 26 is such that the settling rate of the solids is great enough to allow the solids to past downwardly to the higher solid content discharge 92. Therefore, the solid content of the water exiting through the lower solid content discharge 90 is less than the amount of solids passing through the higher solid content discharge 92. A pump 96 can be provided, or other water biasing mechanisms or even a gravity feed type system can be utilized to redirect water back to the upstream portion 78 of the first rinse portion 45.

Therefore, it can be appreciated that the “cleaner” water is removed from the water separating member 26, which in one form is a clarifier tank, and this water is biased or otherwise pumped through a pump-like member 96 through line 98 where it is introduced in a central location along the cylindrical member 60. Then the water passes countercurrent to the flow of the material inside the chamber 62 so the cleaner water is introduced to the material at the central location to have a greater differential of particulate matter to increase the osmotic transfer of particulate matter to the water. Further, after dewatering the water in the first dewatering mechanism 50, the dilution factor is much greater between the raw fibrous material and the water utilized in the second separator 24.

Of course it can further be appreciated that the bath region 76 as shown in FIG. 1 is at an angle with respect to the center axis 68 of the cylindrical member 60. In this form the cylindrical member is at an angle of, for example, between 2°-20° in a broader range with respect to the horizon so as to provide an initial soaking at the input region 70 of the second separator 24. It can further be appreciated that the baffle members 84, as shown in FIG. 2, can be raised at desired heights so as to provide rinsing zones. It should be further noted that between each rinsing zone interposed between two baffle members, the water height could be at different levels. In one form, the foraminous cylindrical member 60 is comprised of a plurality of holes or can be made of a screen; however, a plurality of different methods can be employed to provide the rinsing water to be introduced into the central chamber region 62 of the cylindrical member 60. Further, in a broader scope, the cylindrical member may not be cylindrical but may have another type of shape whereby the operating principle is the internal material advances in the forward direction 66 and the rinse water moves countercurrent thereto, and in one preferred form the rinse water of the first rinse portion 45 is retrieved from a water separating member 26.

Following exit from the output region 72 of the second separator 24, a second dewatering mechanism 28 can be employed. The dewatering mechanism 28 can for example be similar to the dewatering mechanism 50. In general, the fluid discharge region 100 is configured to pass fluid through the pipe section 102 which is in communication with the water separating member 26. Therefore, it can be appreciated that the water separating member receives water, in one form, from the discharge area at the input region 70 of the first separator as well as water with a lower solid content from line 102. Of course the mixture of this water is passed to the first rinsing portion 45. In an alternative form, the line 102 is in direct communication with the line 98 where the water from the second dewatering mechanism is directly passed to the upstream portion 78 in the first rinsing portion of the second separator. In this form, the water separating member operates in a matter wherein the fluid from the dewatering mechanism 28 is reused and the fluid from the input region 70 is directly passed to long-term storage or otherwise positioned to some storage location. Of course in other forms, all of the water from the dewatering mechanism 28 can be directed to the upstream location 78 and a portion from the tank 95 is directed to the upstream portion 78 to provide a sufficient amount of water for the first phase of rinsing of the material.

Downstream of the water separating member 26 is the line 110 which receives fluid from the higher solid content discharge 92. In one form, this fluid is directed through a fluid control trap 112 which in a preferred form comprises first and second conduits 114 and 116. Positioned at the upper portion of the conduits 114 and 116 is an apex region 118 which is positioned at a prescribed height to correspond to the desired fluid height 99 of the tank 95. This system provides for an automatic flow control of the fluid out of the tank 95. In one form, when the lower line 110 is blocked up with material or otherwise a higher volumetric metric flow rate is desired, the valve 118 can be opened, allowing a higher flow-rate through the line 110 which will “blow out” any material contained therein. In one form, downstream of the fluid control tap 112 is the connection line 120 which is in fluid communication with the discharge line 30. In one form, the fluid discharge portion 44, the fluid output portion 58 and the discharge line 120 are all in communication with line 30 taking the fluid to a fluid storage region which one form is a lagoon on a farm.

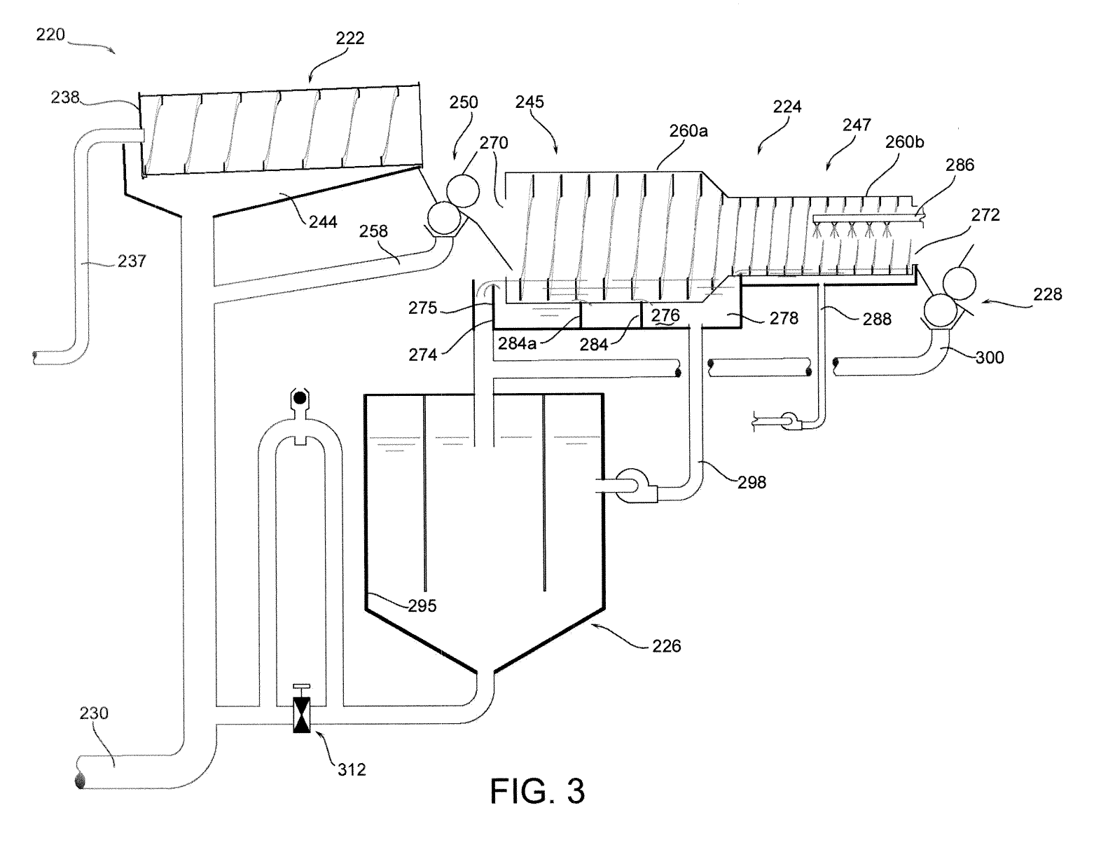

With the foregoing description in place of the first embodiment with reference to FIGS. 1 and 2, there will now be a detailed description of a second embodiment referring to FIG. 3. For ease of explanation, similar components will be described with similar terminology and vernacular and be provided with similar numerals that are incremented by the value of “200”. Of course, the terminology is not necessarily meant to be limiting by way of defining the breadth of the invention, and of course as shown in the second and third embodiments certain components can operate to serve similar functions of the first embodiment and vice versa.

As shown in FIG. 3, the separation system 220 is comprised of a first separator 222, a second separator 224 and a water separation member 226. Further, a second dewatering mechanism 228 can be provided along with other elements such as the fluid control tab 312. The description of the second and third embodiments will be somewhat abbreviated in that similar elements and processes are understood to be described in the first embodiment.

In general, the input line 237 provides the raw material into the first separator 222 at the input region 238. In one form as described above, the first separator 222 is a rotary screen separator coupled with a dewatering mechanism 250. The excreted water is discharged through the fluid discharge portion 244 as well as the fluid output portion 258, where in one form this fluid is directed through the line 232 to long-term storage or otherwise transported to another fluid storage location.

Now referring to the second separator 224, it can be seen in this embodiment that the first rinse portion 245 in this form consists of a section of a cylindrical member 268 which is of a greater diameter than the second rinse portion 247 having a diameter indicated at 260b. The first rinse portion 245 in this form has an upstream portion 278 which receives fluid in one form through line 298 from the clarifier tank 295 or otherwise from a water separating member 226. The rinse water then flows into the central chamber region 262 by way of being directed by the baffles 284 and 284a so the rinse water is directed through the material in the lower portion of the chamber region 262. Thereafter, the water exits the input region 270 over the rearward portion 275 of the base housing 274 and is delivered back to the water separating member 226. The second rinse portion 247 in one form is ejected with water through the line 288 as well as optionally injected internally through the line 286. After the fluid passes through the material contained within the chamber region 262 it can in one form flow towards the tub region 276 of the base housing 274 to mix with the water incoming through line 298. The material exits the output region 272 and then passes in one form through a second dewatering mechanism 228 where the fluid discharge region 300 in one form directs water back to the water separating member 26 or otherwise can be directly reintroduced at the upstream portion 278 of the first rinse portion 245. The material schematically indicated at 219 can then be piled up and transferred by way of a front loader or conveyor or otherwise repositioned and utilized for various purposes. The fluid control valve 312 can operate in a similar manner as described above.

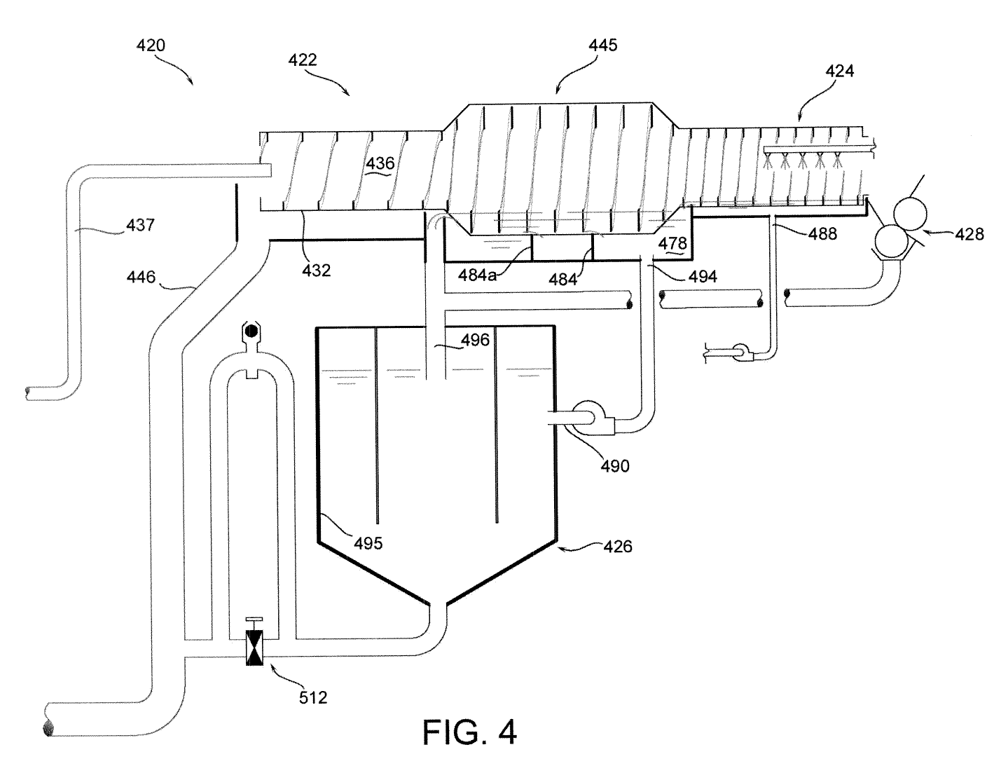

Now referring to FIG. 4, there is shown a third embodiment which is somewhat similar to the previous two embodiments, and the similar components will be incremented by a value of 400 from the first embodiment and, when applicable, by a value of 200 from the second embodiment.

As shown in FIG. 4, the separation system 420 is generally comprised of the first separator 422, the second separator 424 and a water separating member 426. The dewatering mechanism 428 in this form is utilized to again remove water from the material exiting out of the second separator at the output region 472.

In this form, the input line 437 provides the raw material which one form is fibrous material such as manure or post-digester material/manure, and this material is delivered to the first separator 422. In this form, the first separator 422 is only a rotary screen member 432, and the rotary screen member section 432 is of a lesser diameter than the first rinse portion 445 of the second separator 424. In general, fluid passes through holes in the screen 432 and the water is then directed to the line 446 to long-term storage or otherwise to a storage location. The material contained within the chamber region 436 then passes to the second separator and more specifically to the first rinse portion 445. In this form, the first rinse portion has the first rinse fluid input 499 to the upstream portion 478. The water then flows over the baffles 484 and 484a and is transferred through the line 496 to the tank 495 which in one form functions as the water separating member 426. As described in detail above, the low solid content discharge 490 is configured to return the “cleaner” fluid back to the upstream portion 478. The second fluid rinse portion of the second separator operates in a similar manner as described above, in one form having the freshwater input lines 488 as well as the internal chamber discharge mechanism indicated at 489. As with the previous embodiments, a second dewatering mechanism which can possibly be a pair of rollers or a press 428 is used at a fluid control trap 512, or another type of fluid control system such as a variable orifice valve can be utilized to maintain the water level within the tank 495.

Therefore, it can be appreciated that a plurality of methods can be utilized to rinse fibrous material such as manure. While the present invention is illustrated by description of several embodiments and while the illustrative embodiments are described in detail, it is not the intention of the applicants to restrict or in any way limit the scope of the appended claims to such detail. Additional advantages and modifications within the scope of the appended claims will readily appear to those sufficed in the art. The invention in its broader aspects is therefore not limited to the specific details, representative apparatus and methods, and illustrative examples shown and described. Accordingly, departures may be made from such details without departing from the spirit or scope of applicants' general concept.

Therefore I claim:

1. A fiber separation system for separating fluid from a fibrous material, the fiber separation system comprising:
a. a first separator having an input and output region and a fluid discharge portion;
b. a dewatering mechanism having a fluid output portion;
c. a second separator comprising:
i. a cylindrical foraminous member having an outer surface and an internal chamber where an internal augur is positioned, the second separator having an input region and an output region, a bath region being positioned between the input region and the output region,
ii. a base housing comprising a tub region with a baffle member having a partially circular portion configured to be positioned in close proximity to the outer surface of the cylindrical foraminous member being operatively configured to direct fluid from an upstream portion of the bath region to a downstream portion of the bath region whereby the fluid passes from the outer portion of the cylindrical foraminous member to the internal chamber and the fluid path is countercurrent to the general direction of movement of the fibrous material positioned within the cylindrical foraminous member where the fibrous material is biased in a forward direction by way of the internal augur member,
d. where the fluid discharge portion of the first separator and the fluid output portion of the dewatering mechanism communicate and are operatively configured to transfer fluid to a fluid storage region.

2. The fiber separation system as recited in claim 1 where near the input region of the cylindrical foraminous member there is a first water discharge region which is in communication with a water separator member.

3. The fiber separation system as recited in claim 2 where the water separator member has a lower solid content discharge which is in communication with the upstream portion of the base housing.

4. The fiber separation system as recited in claim 3 where located near the output region of the cylindrical foraminous member there is a second fluid rinse operatively configured to discharge fluid having a lesser solid content than the water discharged through the lower solid content discharge of the water separator member.

5. The fiber separation system as recited in claims 3 where there is a second dewatering mechanism following the output region of the second separator and a fluid discharge region of the second dewatering mechanism is in communication with the water separating member.

6. The fiber separation system as recited in claim 5 where the higher solid content discharge of the water separating member is in fluid communication with the fluid storage region.

7. The fiber separation system as recited in claim 6 where the communication of the higher solid content discharge of the water separating member is in communication with a discharge line that is further in communication with the fluid discharge portion of the first separator and the fluid output portion of the dewatering mechanism.

8. The fiber separation system as recited in claim 6 where the water separating member is a clarifier tank where the lower solid content discharge is positioned in the upper portion of the tank and the higher solid content discharge is positioned in the lower portion of the tank and a fluid control trap is in communication with the higher solid content discharge wherein the fluid control trap comprises first and second vertical conduits having an apex region which is positioned at a desirable height for the fluid height level of the fluid in the water separating member.

9. The fiber separation system as recited in claim 1 where a second dewatering mechanism follows the output region of the second separator where a fluid discharge region of the second watering mechanism is in communication with a clarifier tank and positioned near the input region of the second separator is a first water discharge region which is further in communication with the clarifier tank and a lower solid content discharge of the clarifier tank is in fluid communication with the upstream portion of the second separator.

10. The fiber separation system as recited in claim 9 where a second fluid rinse is positioned in a more forward direction in the second separator with respect to the upstream portion whereby the second fluid rinse provides fluid with a lesser solid content than the fluid from the clarifier tank discharged through the lower solid content discharge to the upstream portion of the second separator.

11. The fiber separation system as recited in claim 1 where the second separator has the cylindrical foraminous member positioned at an angle whereby the input region is positioned at a lower elevation than the output region.

12. The fiber separation system as recited in claim 11 where a plurality of baffle members are positioned between the upstream portion and the downstream portion of the second separator.

13. The fiber separation system as recited in claim 1 where the first separator and the dewatering mechanism are both comprised within the inherent utility of a first cylindrical foraminous member having an internal augur.

14. The fiber separation system as recited in claim 13 where the first cylindrical foraminous member is operatively connected to the second separator whereby the second separator is provided with the cylindrical foraminous member having a larger cross-sectional diameter than the first cylindrical foraminous member.

15. The fiber separation system as recited in claim 14 where the second separator having the larger diameter cylindrical foraminous member is positioned within the base housing at a first rinse portion that provides a tub for having fluid positioned therein and the base housing has a first rinse fluid input located in the upstream portion and a first rinse fluid output located in the downstream portion with the baffle member positioned therein between.

16. The fiber separation system as recited in claim 15 where the second fluid rinse is positioned in the second separator where the second separator has a second fluid rinse portion whereby the diameter of the cylindrical foraminous member in this portion is smaller than the diameter of the second separator of the first rinse portion.

17. The fiber separation system as recited in claim 15 where the first rinse fluid input provides fluid from a water separating member from a lower solid content discharge of the water separating member.

18. The fiber separation system as recited in claim 1 where the second separator has a first rinse portion where the upstream portion discharges water therein which is configured to pass over the baffle member to the downstream portion and then the water is discharged to a water separating member and the second separator further has a second rinse portion having water discharge therein that is purer than the water inserted at the upstream portion of the first rinse portion.

19. A method of dewatering fibrous material comprising:
a. positioning fibrous material into a first separator removing a portion of the fluid within the fibrous separator therefrom,
b. transferring the fibrous material to a second separator at an input region where the second separator is comprised of a cylindrical member comprising a plurality of fluid access ports providing communication to an internal chamber region and having an internal helical member configured to advance the fibrous material when the cylindrical member is rotated,
c. providing a first rinse portion having an upstream portion and a downstream portion where the upstream portion is positioned in a more forward location in the downstream portion with respect to the input region of the second separator whereby the upstream portion has a first rinse fluid input where the water is directed to the downstream portion and into the internal chamber region of the second separator and the fluid is counter-current to the advancing of the fibrous material in the second separator,
d. a second rinse portion positioned in a more forward location along the second separator where a second fluid rinse discharges fluid which is of a lower solid content than the fluid in the first rinse portion,
e. directing the fibrous material from the output region of the second separator to a dewatering mechanism where the fluid discharge region of the dewatering mechanism transfers fluid from the fibrous material to a water separating member and further water discharged from the first rinse portion is transferred to the water separating member and a lower solid content discharge of the water separating member discharges water to the upstream portion of the first rinse portion of the second separator.

20. The method as recited in claim 19 where the water separating member further has a higher solid content discharge which discharges water at a higher solid content than the water discharge at the lower solid content discharge and the fluid is passed from the higher solid content discharge to a fluid storage region.

21. The method as recited in claim 19 where the first separator has a fluid discharge portion which discharges fluid to a fluid storage region.

22. The method as recited in claim 19 where the water separating member is a clarifier tank and the diameter of the clarifier tank is such that the input from the fluid discharge region of the dewatering mechanism and the fluid discharge of the first rinse portion of the second separator is such that the mean settling rate of solids within the water separating member is such that solids are allowed to pass downwardly to the higher solid content discharge and a lower solid content discharge is positioned in an upper portion of the water separating member.

23. A dewatering mechanism comprising:
a. a first separator configured to remove a portion of the water of contents positioned therein the first separator,
b. a second separator having a first rinse portion with a first rinse fluid input that is configured to transfer water from a water separating member from a lower solid content discharge line, the first rinse portion having a discharge region which is in communication with the water separating member,
c. a second rinse portion providing fluid of a lower solid content than the fluid within the first rinse fluid input line of the first rinse portion of the second separator,
d. a dewatering mechanism in communication with an output region of the second separator configured to receive contents therefrom, the dewatering mechanism further having fluid discharge region which is in communication with the water separating member.

24. The dewatering mechanism as recited in claim 19 where the second separator is a foraminous cylindrical member having an internal augur member configured to advance material therein and a countercurrent flow with respect to the first rinse fluid input and fluid output lines in the first rinse portion of the second separator.

25. The dewatering mechanism as recited in claim 24 where a plurality of baffle members are positioned in the first rinse portion where the baffle members have a partially circular surface configured to engage an outer surface of the foraminous cylindrical member.

26. The dewatering mechanism as recited in claim 24 where the water separating member has a higher solid content discharge which discharges fluid at a higher solid content than the fluid within the lower solid content discharge and the fluid from the higher solid content discharge is in communication with the fluid of the first separator and is passed to a fluid storage region.

27. The dewatering mechanism as recited in claim 26 where the fluid storage region is a lagoon.

28. The dewatering mechanism as recited in claims 26 where the higher solid content discharge passes to a fluid control tab having first and second vertical conduits with an apex region positioned at a height to match the desired fluid height of the fluid within the water separating member.

29. The dewatering mechanism as recited in claim 23 where the second separator is a foraminous cylindrical member having a central axis that is at an incline from an input region to the output region and the first rinse portion is provided with a base housing providing a tub having a water level that is lower at an upstream portion of a first baffle member and a downstream portion which is positioned toward the input region with respect to the upstream portion.

30. The dewatering mechanism as recited in claim 23 where the first separator is a rotary screen having an internal augur member and a dewatering press is positioned thereafter to remove water therefrom to increase the dilution factor of the material passing to the second separator.

31. The dewatering mechanism as recited in claim 23 where the first separator and the second separator are of a unitary structure wherein the first separator is a foraminous screen with a diameter that is lower than the first rinse portion of the second separator.

32. The dewatering mechanism as recited in claim 31 where the first rinse portion of the second separator is operatively configured to be positioned within a base housing having a rinse fluid therein from the water separating member where the material advances in a forward direction that is countercurrent to the flow of the water supplied from the water separating member.
